(19) United States
(12) Patent Application Publication
(10) Pub. No.: US 2019/0240749 A1
(43) Pub. Date: Aug. 8, 2019

(54) BAND SAW FOR SAWING A RAIL OF A TRACK

(71) Applicant: ROBEL BAHNBAUMASCHINEN GMBH, FREILASSING (DE)

(72) Inventors: OTTO WIDLROITHER, FREILASSING (DE); FABIAN EHRLER, SAALDORF-SURHEIM (DE)

(21) Appl. No.: 16/340,158

(22) PCT Filed: Sep. 20, 2017
(86) PCT No.: PCT/EP2017/001108

§ 371 Date: Apr. 8, 2019

(30) Foreign Application Priority Data
Oct. 7, 2016 (DE) 202016006226.4

(51) Int. Cl. B23D 55/08; B23D 53/00; B23D 55/06; E01B 31/04

(52) U.S. Cl. CPC B23D 55/082; E01B 31/04; B23D 55/06; B23D 53/003

(57) ABSTRACT

A band saw for sawing a rail of a track is configured for fastening to a vice which can be clamped onto the rail and is provided with a feed device. The band saw includes a frame in which four saw band rollers are mounted. A saw band is stretched around the four saw band rollers and, in a recess of the frame, the saw band is twisted into a sawing plane by guiding elements. Due to the utilization of four saw band rollers, there is little wear of the saw band, resulting in a longer service life.

### FIELD OF TECHNOLOGY

The invention relates to a band saw for sawing a rail of a track, designed to be fastened to a vice which can be clamped onto the rail and is provided with a feed device.

### PRIOR ART

A band saw of this kind is known, for example, from DE 298 20 411 U1. In this, an endless saw band is stretched around three saw band rollers in a frame. The three rollers are arranged in the shape of a triangle. For sawing a rail, a vice comprising a feed device is first clamped onto the rail.

Then the actual sawing procedure takes place, wherein the band saw is moved downward in a tilted position by means of the feed device. In order to saw through an entire rail height, a severe tilting of the band saw is required, resulting in a heavy strain on the saw band.

### SUMMARY OF THE INVENTION

It is the object of the invention to provide an improvement over the prior art for a band saw of the type mentioned at the beginning.

According to the invention, this object is achieved by way of the features of claim 1. Dependent claims indicate advantageous embodiments of the invention.

In this, the band saw comprises a frame in which four saw band rollers are mounted, wherein a saw band is stretched around the four saw band rollers and wherein, in a recess of the frame, the saw band is twisted into a sawing plane by means of guiding elements. Due to the arrangement of four saw band rollers, there is less stress on the saw band which results in a longer service life. One the one hand, the bending stress is minimized and, on the other hand, the wear is distributed over a saw band which is long in proportion to the frame dimensions.

A favourable embodiment provides that the saw band is twisted in the recess of the frame about an angle of at most 25°, preferably 20°. On the one hand, due to the slight twisting there is only little wear. On the other hand, the frame can be realized with small width, since there is no necessity for great distances between saw band roller and guiding element in order to twist the saw band.

It is further advantageous if each saw band roller deflects the saw band about an angle of between 80° and 100°, so that the arrangement of the saw band rollers is approximately rectangular. This results in a minimization of the wear on the saw band and a compact design of the band saw.

A favourable design of the recess of the frame exists if the same is wider in a front area located nearer to the sawing plane than in a rear area remote from the sawing plane. This brings about a high stability of the frame. At the same time, an entire rail height can be severed since the front area of the recess is wider than a rail base to be sawed through. Only the rear area of the recess is narrower, but still wider than a rail head to be sawed through.

Advantageously, two front saw band rollers, as seen from the sawing plane, are arranged in each case to the left and right of the recess of the frame, and two rear saw band rollers are arranged in each case to the left and right of the recess. Thus, a particularly compact design of the band saw id provided.

In this, it is favourable if the recess of the frame intersects a plane established by axes of rotation of the rear saw band rollers. The recess is therefore particularly deep as seen from the sawing plane, so that rails having a great rail height can be severed.

It is additionally favourable for the design of the band saw if the rear saw band rollers have a greater outer diameter than the front saw band rollers. With sufficient distance to the guiding elements, the smaller dimensions of the front saw band rollers enable a very slim design of the band saw. In this manner, even in the event of tight space conditions, a collision with other rails or track equipment is avoided.

In this it is favourable if a rear saw band roller is driven by a motor. Due to the greater outer diameter of the rear saw band roller, there is sufficient friction between saw band roller and saw band to avoid a slippage of the saw band. Additionally, there is sufficient space in the area of the rear saw band rollers to arrange the motor.

Usefully, a rear saw band roller is also mounted for displacement by means of a tensioning device in order to tension the saw band. Thus it is possible that the same saw band roller is used for driving and for tensioning the saw band, wherein sensibly the entire drive unit, including the motor and optionally a transmission gearing, is arranged displaceably.

In a further development of the invention it is provided that the guiding elements are fastened to the frame for displacement relative to each other. With this it is possible to adapt the length of the useable saw band section to a rail width. In the case of slim rails, the distance between the particular guiding element and the adjacent saw band roller can be increased in order to minimize the twisting wear of the saw band.

Advantageously, each guiding element comprises two guide rollers which guide the saw band with little friction. In this, it is favourable if the two guide rollers of a guiding element are arranged to be displaceable relative to each other to facilitate removing or installing the saw band.

It is additionally advantageous if at least one guiding element has a guiding plate with a slot for guiding the saw band. This plate is manufactured from a particularly hard metal and minimizes the wear on the guiding elements.

It is favourable for the stability of the band saw if the recess of the frame is bridged by a bracket, and if the bracket comprises a connecting device for fastening the band saw to the vice. In this, the bracket reinforces the stiffness of the frame, whereby a high cutting quality is ensured.

For enhancing safe operation and for further improving the frame stiffness, it is useful if the frame has a removable cover on an underside.

### BRIEF DESCRIPTION OF THE DRAWINGS

The invention will be described by way of example below with reference to the attached figures. There is shown in schematic representation in:

FIG. 1 a perspective view of a band saw

FIG. 2 band saw from below without cover

FIG. 3 band saw on a vice prior to a sawing operation

FIG. 4 band saw on a vice after a sawing operation

### DESCRIPTION OF THE EMBODIMENTS

FIG. 1 shows the band saw 1 as seen diagonally from above. Arranged on the visible upper side of a frame 2 are a motor 3, a tensioning device 4 and a bracket 5 for bridging a recess 6 of the frame 2. A section a of a saw band 7, usable for sawing, extends in the recess 6.

The bracket 5 has a connecting device 8 by means of which the band saw 1 can be fastened to a vice 9. In the present case, the connecting device 8 comprises a connecting plate 10 which is aligned parallel to a sawing plane 11 and has, at the lower edge, two oblong holes open towards the bottom. With this, the connecting plate 10 can be hung in protruding bolts of a feed device 12 of the vice 9. Thus there is only one interface with the vice 9, resulting in a high stiffness of the entire system.

For lifting and adjusting the band saw 1, a rod assembly 13 is arranged on the frame 2. This serves simultaneously as a protective device against damage to the band saw 1 at a construction site or on a loading surface. A further safety element is formed by a cover 14 attached at an underside of the frame 2. Detachable fastenings are provided to enable removal of the cover 14 for maintenance purposes.

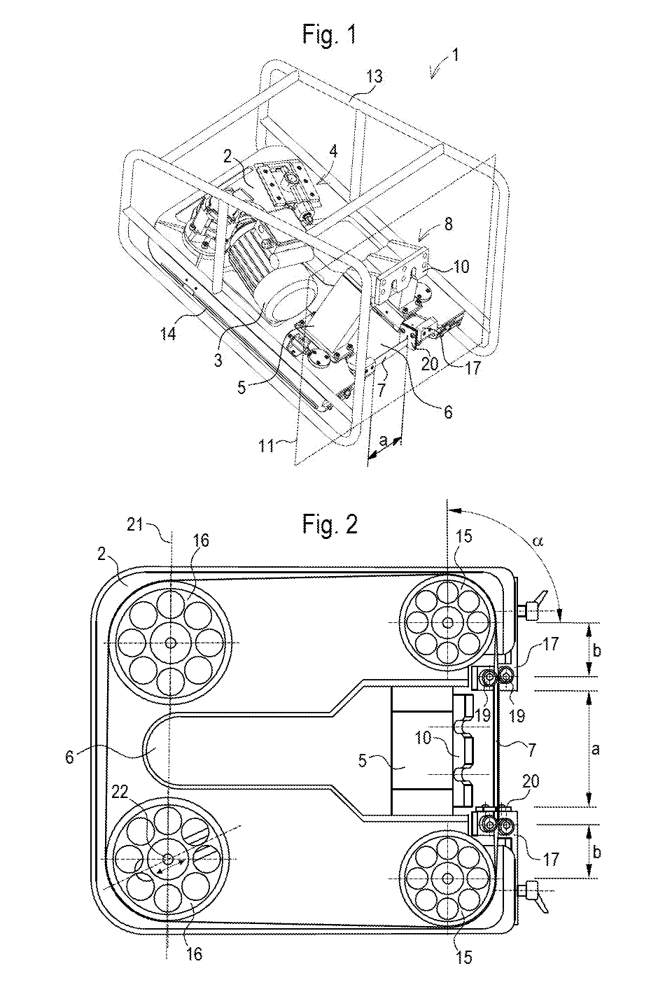

In FIG. 2, the band saw 1 is shown from below, wherein the front side with the connecting plate 10 is oriented to the right. The saw band 7 is tensioned around two front saw band rollers 15 and two rear saw band rollers 16. In this, each saw band roller 15, 16 deflects the saw band 7 about an angle α of approximately 90°, so that the saw band rollers 15, 16 are arranged roughly in a rectangle.

Located between the front saw band rollers 15 is the section a of the saw band 7 which is usable for sawing. In this section a, the saw band 7 is twisted into the sawing plane 11 by means of two guiding elements 17. A sufficient distance b between the respective front saw band roller 15 and the adjoining guiding element 17 reduces the wear of the saw band 7 during twisting.

The guiding elements 17 are fastened to the frame 2 in a manner allowing displacement relative to one another, so that the distance b available for twisting can be increased when sawing narrow rails 18. Each guiding element 17 comprises two guide rollers 19 which are mounted on eccentrics. By rotating the eccentrics, the guide rollers 19 can be adjusted relative to one another. At least one guiding element 17 further comprises a guiding plate 20 having a slot in which the saw band 7 is additionally guided.

The recess 6 is designed wider in the front region close to the sawing plane 11 than in the rear region between the two rear saw band rollers 16. Thus, the rear saw band rollers 16 can be designed with a greater diameter than the front saw band rollers 15. This increases the friction between the saw band 7 and the powered rear saw band roller 15 and reduces the bending stress of the saw band 7.

Advantageously, the recess 6 of the frame 2 is routed backwards far enough to intersect a plane 21 defined by axes of rotation of the rear saw band rollers 16. This enables a smaller inclination of the band saw 1 with limited depth of the frame 2 and thus less twisting of the saw band 7.

The arrangement of the saw band rollers 15, 16 and the smaller diameter of the front saw band rollers 15 additionally allow a limited width of the frame 2. Thus, the band saw 1 remains usable even in constricted space conditions. This in important particularly when sawing in the area of switches and crossings, where rails 18 run in immediate proximity to one another. The same goes in the event of an additional conductor rail.

For tightening the saw band 7, one rear saw band roller 16 is mounted in a displaceable bearing 22. Specifically, the tensioning device 4 comprises a guide of the bearing 22 fastened in the frame 2 and a threaded spindle as an adjustment device. In this, the tensioning direction indicated by a double arrow extends in a diagonal of the frame 2 and allows a great adjustment path. An operating element for turning the threaded spindle can be configured to be removable. Thus, a compact design is ensured.

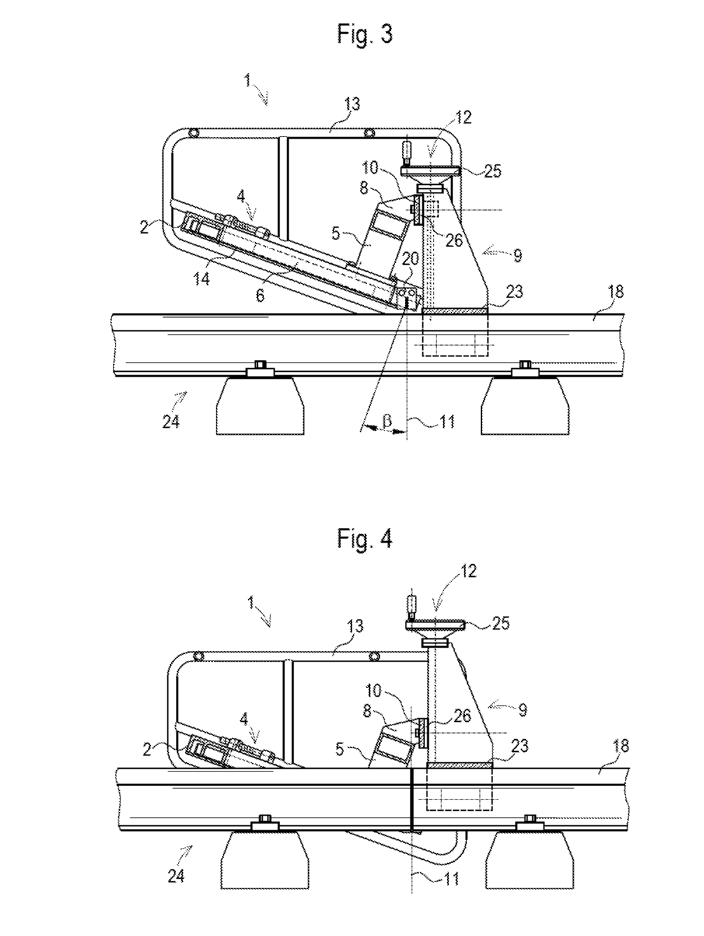

FIGS. 3 and 4 show the band saw 1 in operation mounted on a vice 9. The band saw 1 and a base 23 of the vice 9 are shown in section. The vice 9 encloses with the base 23 the rail 18, to be sawed, of a track 24. The base 23 is clamped fast to the rail web by means of damping screws. A carriage 26 of the feed device 12 is vertically adjustable by means of a hand wheel 25.

The band saw 1 is mounted on the carriage 26 by the connecting plate 10. In this, the band saw 1 is inclined at an angle β in order to avoid a collision with the rail 18 during sawing. The usable section a of the saw band 7 is twisted into the sawing plane 11 about said angle β. The four saw band rollers 15, 16 and the deep recess 6 of the frame 2 enable a small angle β of, for example, 20°.

With the saw band 7 running, the band saw 1 is moved downward by means of the feed device 12 at a suitable feeding speed. The long saw band 7 and the slight bending stress due to the four saw band rollers 15, 16 allow a high circulation velocity. This, in turn, enables a high feeding speed and thus short cutting times.

In FIG. 4, the severed rail 7 and the band saw 1 are shown in their end position. Due to the recess 6 of the frame 2 and the sufficient height of the bracket 5, there is no collision between the band saw 1 and the rail 18.

A change of the saw band 7 can be accomplished in a simple manner. To that end. it is merely necessary to remove the cover 14 and to relieve the saw band 7 by means of the tensioning device 4. Optionally, the guide rollers 19 can also be opened. As a result of there being little bending stress of the saw band 7, there is no danger of injury.

The invention also relates to other embodiments having at least four saw band rollers 15, 16. For example, a separate tensioning roller may be provided, so that the saw band 7 is tensioned around the remaining four saw band rollers 15, 16 by means of said fifth roller.

1-15. (canceled)

16. A band saw for sawing a rail of a track, wherein the band saw is to be fastened to a vice that is to be clamped onto the rail and that is provided with a feed device, the band saw comprising:
a frame with four saw band rollers mounted thereon;
an endless saw band stretched around said four saw band rollers; and
guiding elements disposed to twist said saw band within a void of said frame into a sawing plane.

17. The band saw according to claim 16, wherein said guiding elements are configured to twist said saw band in the recess of said frame about an angle of at most 25°.

18. . The band saw according to claim 17, wherein said guiding elements are configured to twist said saw band about an angle of no more than 20°.

19. The band saw according to claim 16, wherein each said saw band roller deflects said saw band about an angle of between 80° and 100° and said saw band oilers are approximately arranged in a rectangle.

20. The band saw according to claim 16, wherein the recess of said frame is wider in a front area located nearer to the sawing plane than in a rear area remote from the sawing plate.

21. The band saw according to claim 20, wherein two front saw band rollers, as seen from the sawing plane, are arranged in each case to the left and right of the recess of said frame, and two rear saw band rollers are arranged in each case to the left and right of the recess.

22. The band saw according to claim 21 wherein the recess of said frame intersects a plane established by axes of rotation of the rear saw band rollers.

23. The band saw according to claim 21 wherein the rear saw band rollers have a greater outer diameter than the front saw band rollers.

24. The band saw according to claim 21, her comprising a motor disposed to drive a rear saw band roller.

25. The band saw according to claim 21, wherein one of the rear saw band rollers is displaceably mounted, and further comprising a tensioning device configured for displacing a rear saw band roller.

26. The band saw according to claim 16, wherein said guiding elements are fastened to said frame for displacement relative to each other.

27. The band saw according to claim 16, wherein each guiding element comprises two guide rollers.

28. The band saw according to claim 27, wherein said two guide rollers of a respective said guiding element are displaceably mounted relative to each other.

29. The band saw according to claim 16, wherein at least one said guiding element has a guiding plate with a slot for guiding the saw band.

30. The band saw according to claim 16, further comprising a bracket disposed to bridge the recess of said frame, said bracket comprising a connecting device for fastening the band saw to the vice.

31. The band saw according to claim 16, wherein said frame has a removable cover on an underside.

32. A band saw apparatus for sawing a rail of a track, the apparatus comprising:
a vice to be clamped onto the rail;
a band saw to be fastened to said vice, said band saw having:
a frame with four saw band rollers mounted thereon;
an endless saw band stretched around said four saw band rollers: and
guiding elements disposed to twist said saw band within a void of said frame into a sawing plane; and
said vice having a feed device configured to move said saw band in the sawing plane transversely to the rail.

33. The band saw according to claim 32, wherein said rollers are disposed substantially in a rectangular arrangement within a plane that is inclined relative to the rail by an angle of at most 25° and said guiding elements are configured to twist said saw band about the angle.
